(19) United States
(12) Patent Application Publication
(10) Pub. No.: US 2015/0056329 A1
(43) Pub. Date: Feb. 26, 2015

(54) FOOD COMPOSITIONS FOR STIMULATING THE FORMATION OF BONE TISSUE

(71) Applicant: YOPLAIT FRANCE, PARIS (FR)

(72) Inventors: Brigitte Rousseau, Torfou (FR); Emilien François Rouy, Paris (FR); François Michel Blachier, Colombes (FR)

(21) Appl. No.: 14/388,302

(22) PCT Filed: Mar. 28, 2013
(86) PCT No.: PCT/FR2013/050685

§ 371 Date: Sep. 26, 2014

(30) Foreign Application Priority Data
Mar. 28, 2012 (FR) 1252788

(51) Int. Cl. A23J 1/20; A23C 19/04; A23C 9/123

(52) U.S. Cl. CPC A23J 1/202; A23C 9/123; A23C 19/041
USPC 426/36; 426/42; 426/43

(57) ABSTRACT

The present invention relates to the preparation of food compositions capable of improving the bone status of the consumer by promoting bone tissue formation. In particular, it relates to the use of milk protein proteolysates for the preparation of these compositions.

The present invention relates to the preparation of food compositions capable of modifying the equilibrium between bone tissue formation and bone resorption by promoting osteoblast proliferation and differentiation.

### TECHNOLOGICAL BACKGROUND OF THE INVENTION

Bone is a tissue which undergoes perpetual renewal through the action of two types of bone cells: osteoblasts and osteoclasts. The solidity of bone is the result of a subtle equilibrium between these two cell types.

Osteoblasts are responsible for the synthesis of the osteoid matrix and for the mineralization thereof. They differentiate from osteoprogenitor cells located in the periosteum. Once they are entirely surrounded by the mineralized bone matrix, they transform into osteocytes and retain metabolic functions in calcium exchange phenomena.

Osteoclasts are responsible for bone resorption. They come from a haematopoietic progenitor and belong to the macrophage family. Osteoclasts bind to the bone matrix by means of adhesive proteins, thus creating a sealed compartment (or Howship's lacuna). The matrix region thus delimited is then degraded by dissolution of the mineral phase by acidification of the compartment and by degradation of the protein matrix under the action of lysosomal enzymes and of collagenases.

The production of functional osteoblasts and osteoclasts involves two major steps: (i) a proliferation step during which the progenitor cells will multiply and (ii) a differentiation step during which the progenitor cells will differentiate, according to their type, into functional osteoblasts or osteoclasts.

An imbalance between osteoclast activity and osteoblast activity can result in the occurrence of various pathological bone conditions, including osteoporosis, which is characterized by greater osteoclast activity than osteoblast activity. This pathological condition therefore results in excessive brittleness of the skeleton and in an increased risk of fracture. Drug treatments recommended in the prevention of osteoporosis-related fractures, such as bisphosphonates, exist. However, owing to the possibilities of side effects, these treatments are preferably administered to patients with a high risk of fractures, in particular of vertebral fractures.

An appropriate diet can also make it possible to improve bone status. It is in fact acknowledged that a sufficient calcium intake, of at least 800 mg per day, ideally combined with a vitamin D intake, helps to preserve bone solidity. This daily intake can come from various foods with a high calcium content, in particular dairy products.

Over the past few years, studies have been carried out in order to propose food compositions capable of having a beneficial effect on bone status and therefore of being of interest in the prevention of bone disorders such as osteoporosis, without however causing side effects in the consumer.

To date, most of the efforts have been concentrated on the identification of molecules capable of limiting bone resorption by inhibiting osteoclast proliferation, differentiation and/or activity (for example, international patent application WO 2010/028432). It would also be extremely beneficial to obtain food compositions capable of stimulating bone formation by promoting osteoblast activity.

### SUMMARY OF THE INVENTION

The objective of the present invention is to provide food compositions, preferably dairy products, capable of improving the bone status of the consumer by stimulating or promoting osteoblast activity.

The present invention therefore relates to the use of a proteolysate of one or more milk proteins for the preparation of a food composition for promoting the proliferation of bone marrow progenitor cells, the differentiation of said cells into osteoblasts and/or osteoblast activity.

The proteolysate may be a proteolysate of a protein chosen from the group consisting of caseins, in particular αS1, αS2, β and κ caseins, β-lactoglobulin, α-lactalbumin and a mixture thereof.

The proteolysate may be a casein proteolysate. It may in particular be a proteolysate of a protein chosen from the group consisting of αS1 casein, αS2 casein, β casein, κ casein, γ casein, and a mixture thereof.

It may also be a proteolysate of a protein chosen from the group consisting of αS1 casein, αS2 casein, β casein, κ casein, and a mixture thereof. In particular, the proteolysate is a proteolysate of a protein chosen from the group consisting of αS1 casein, αS2 casein, β-lactoglobulin, α-lactalbumin, and a mixture thereof.

The proteolysate may be a proteolysate of a protein chosen from the group consisting of β-lactoglobulin, α-lactalbumin, and a mixture thereof.

It may also be an α casein proteolysate, and in particular a proteolysate of a protein chosen from the group consisting of αS1 casein, αS2 casein and a mixture thereof.

The proteolysate may be obtained by digestion with one or more enzymes having an endopeptidase and/or exopeptidase activity. In particular, the enzyme(s) may be chosen from the group consisting of serine endopeptidases, cysteine endopeptidases, aspartate endopeptidases and metallo-endopeptidases, preferably from serine endopeptidases. Preferably, the proteolysate is obtained by digestion with an enzyme chosen from the group consisting of chymotrypsin and trypsin, and a mixture thereof.

The proteolysate may also be obtained by microbial fermentation.

Before use, the proteolysate may be subjected to size fractionation, in particular by ultrafiltration via centrifugation.

According to one particular embodiment, the proteolysate essentially comprises peptide fragments having a molecular weight greater than 3 kDa. According to another particular embodiment, the proteolysate essentially comprises peptide fragments having a molecular weight greater than 10 kDa. Alternatively, the proteolysate essentially comprises peptide fragments having a molecular weight of between 3 and 10 kDa.

The proteolysate can promote the proliferation of bone marrow progenitor cells. It can also promote the differentiation of osteoprogenitor cells into osteoblasts. According to one preferred embodiment, the proteolysate promotes the proliferation of bone marrow progenitor cells and the differentiation of osteoprogenitor cells into osteoblasts. The proteolysate can also promote osteoblast activity, in particular bone matrix mineralization. Optionally, the proteolysate is, in addition, capable of inhibiting the proliferation, differentiation and/or resorption activity of osteoclasts.

The food composition is preferably intended for human consumption. According to one particular embodiment, the food composition is a food, a food supplement or a beverage. According to one preferred embodiment, the food composition is a dairy product. In particular, the dairy product may be a fermented milk, preferably a yoghurt, or an unripened cheese, preferably a fresh cheese.

The present invention also relates to a food composition comprising the proteolysate according to the invention and capable of promoting the proliferation of bone marrow progenitor cells, the differentiation of said cells into osteoblasts and/or osteoblast activity.

### BRIEF DESCRIPTION OF THE DRAWINGS

FIG. 1 represents the effect of undigested total caseins (αS1, αS2, β and κ) and of total casein proteolysates obtained by digestion with chymotrypsin or trypsin, on bone cell proliferation (DNA: amount of DNA) and osteoblast differentiation (AP/DNA: ratio of the alkaline phosphatase activity to the amount of DNA). The results are presented in the form of a ratio of the values obtained with the sample tested to the values obtained with the neutral control (BSA control), i.e. with bovine serum albumin (T/C ratio). These ratios are calculated for each culture plate and then grouped together. Lactoferrin is used as a positive control. *P<0.05, **P<0.01, ***P<0.001.

FIG. 2 represents the effect of undigested α caseins (αS1 and αS2) and of α casein (αS1 and αS2) proteolysates obtained by digestion with chymotrypsin or trypsin, on bone cell proliferation (DNA) and osteoblast differentiation (AP/DNA). The results are presented in the form of a ratio of the values obtained with the sample tested to the values obtained with the neutral control (BSA control) (T/C ratio). These ratios are calculated for each culture plate and then grouped together. Lactoferrin is used as a positive control. *P<0.05, **P<0.01, ***P<0.001.

FIG. 3 represents the effect of undigested serum proteins and of serum protein proteolysates obtained by digestion with chymotrypsin or trypsin, on bone cell proliferation (DNA) and osteoblast differentiation (AP/DNA). The results are presented in the form of a ratio of the values obtained with the sample tested to the values obtained with the neutral control (BSA control) (T/C ratio). These ratios are calculated for each culture plate and then grouped together. Lactoferrin is used as a positive control. *P<0.05, **P<0.01, ***P<0.001.

FIG. 4 represents the photographs of observations under a microscope with the x4 objective of wells of cell cultures stained with alizarin red for the cultures in the presence of 0.01 mg/ml of BSA, of 0.01 mg/ml of lactoferrin and of 0.01 mg/ml of the CR10 fraction.

FIG. 5 represents the quantification by colorimetry of the solution obtained by dissolving the mineralization nodules stained with alizarin red. The results are presented in the form of a ratio of the values obtained with lactoferrin or the CR10 fraction to the values obtained with the neutral control (BSA control) (T/C ratio). *P<0.05.

FIG. 6 represents the effect of the CR10 fraction, with or without heat treatment (96° C. for 4 min), on bone cell proliferation and osteoblast differentiation. The results are presented in the form of a ratio of the values obtained with the sample tested to the values obtained with the neutral control (BSA control) (T/C ratio). Lactoferrin is used as a positive control. *P<0.05, **P<0.01, ***P<0.001.

### DETAILED DESCRIPTION OF THE INVENTION

The inventors have demonstrated, surprisingly, that milk protein proteolysates, i.e. proteolysates of caseins and of serum proteins, have a positive effect on the proliferation of bone marrow progenitor cells, on the differentiation of osteoblasts and/or on osteoblast activity.

The present invention therefore relates to the use of a proteolysate of one or more milk proteins for the preparation of a food composition for promoting the proliferation of bone marrow progenitor cells, the differentiation of said cells into osteoblasts and/or osteoblast activity.

Milk contains essentially two groups of proteins: caseins, which represent 80% of total milk proteins, and serum proteins, which are found in whey.

There are five caseins: αS1 casein, αS2 casein, β casein, κ casein and γ casein. αS1 casein represents between 34% and 40% of caseins and has a molecular weight of 24 kDa. αS2 casein represents approximately 10% of caseins and has a molecular weight of 25 kDa. β casein represents approximately 34% of caseins and has a molecular weight of 24 kDa. κ casein represents 8% to 15% of caseins and has a molecular weight of 19 kDa. γ casein, which is derived from proteolysis of β casein, represents approximately 7% of caseins and has a molecular weight of 23 kDa.

Serum proteins are essentially composed of β-lactoglobulin and α-lactalbumin. β-Lactoglobulin represents 65% of whey proteins and has a molecular weight of 18 kDa. α-Lactalbumin represents 25% of whey proteins and has a molecular weight of approximately 14 kDa (Pierre Jouan, Lactoprotéines et lactopeptides: propriétés biologiques [Lactoproteins and lactopeptides: biological properties], Paris: INRA [French National Instituted for Agronomic Research], 2002).

Thus, the term “milk protein”, as used in this document, refers to a protein which is naturally present in milk, preferably a protein chosen from the group consisting of caseins and serum proteins, and in particular from the group consisting of αS1 casein, αS2 casein, β casein, κ casein, γ casein, β-lactoglobulin and α-lactalbumin.

The milk proteins may be contained in milk or in a preparation obtained from milk. In particular, they may be totally or partially purified. As used in this document, the term “totally purified” means that the product of interest is free of any detectable contaminant.

Preferably, the milk is mammalian milk. More particularly preferably, the mammal is a cow, a ewe, a goat, a female buffalo, a female camel or a mare, preferably a cow.

As used in this document, the term “proteolysate” refers to a product obtained by digestion of proteins by means of one or more enzymes or proteases. In particular, the proteolysate can be obtained by digestion with one or more enzymes having an endopeptidase and/or exopeptidase activity.

According to one embodiment, the proteolysate is obtained by digestion with one or more enzymes having an endopeptidase activity. These enzymes can be, for example, chosen from the group consisting of serine endopeptidases (EC 3.4.21), cysteine endopeptidases (EC 3.4.22), aspartate endopeptidases (EC 3.4.23) and metallo-endopeptidases (EC 3.4.24).

Preferably, the enzyme(s) used is (are) authorized by French legislation in the production of food products. These enzymes can be, for example, without being limited thereto, chymotrypsin extracted from bovine pancreas, trypsin, chymosin from Aspergillus niger variety Awamori containing a calf prochymosin B gene, chymosin derived from a strain of Aspergillus niger variety Awamori carrying a gene encoding domestic dromedary chymosin, chymosin from Kluyveromyces lactis containing a calf prochymosin B gene, chymosin from Escherichia coli K-12 containing a calf prochymosin A gene, chymosin extracted from calf rennet, papain from Carica papaya, bovine pepsin, porcine pepsin, the serine protease derived from the genetically modified strain of Fusarium venenatum containing the gene encoding the Fusarium oxysporum protease, the proteases from Aspergillus oryzae, Bacillus amyloliquefaciens, Bacillus licheniformis, Aspergillus niger GEP-44, Geobacillus caldoproteolyticus Rokko non-transformed AZ 3173s, Rhizomucor miehei, Micrococcus caseolyticus, Bacillus subtilis, Aspergillus wentii, Endothia parasitica and Mucor pusillus lindt, the aminopeptidases from Aspergillus niger EPD-4 and Aspergillus oryzae, the aspartyl protease from Aspergillus oryzae containing the gene encoding the Rhizomucor miehei protease or the serine carboxypeptidase derived from a genetically modified Aspergillus niger strain PEG-1A containing a gene encoding the Aspergillus niger carboxypeptidase.

Preferably, the enzyme(s) used belong(s) to the serine endopeptidase family. Particularly preferably, the enzymes used comprise, or consist of, trypsin (EC 3.4.21.4) and/or chymotrypsin (EC 3.4.21.1).

According to one embodiment, the proteolysate is obtained by digestion of the proteins with trypsin. According to another embodiment, the proteolysate is obtained by digestion of the proteins with chymotrypsin.

The proteolysate can be obtained by digestion with totally or partially purified enzymes.

It can also be obtained by microbial fermentation. The milk proteins to be digested are in this case brought into contact with one or more microbial strains, preferably bacteria and/or yeasts, which express the enzyme(s) of interest. The bacteria can be, for example, chosen from the group consisting of bacteria belonging to the genera Arthrobacter, Bacillus, Bifidobacterium, Brevibacterium, Corynebacterium, Enterobacter, Enterococcus, Hafnia, Halomonas, Kocuria, Lactobacillus, Lactococcus, Leuconostoc, Micrococcus, Oenococcus, Pediococcus, Propionibacterium, Staphylococcus and Streptococcus. The yeasts can be, for example, chosen from the group consisting of yeasts belonging to the genera Candida, Debaryomyces, Geotrichum, Hansenula, Kluyveromyces, Pichia, Saccharomyces and Williopsis.

According to one embodiment, the proteolysate is a proteolysate of a protein chosen from the group consisting of caseins and serum proteins, and a mixture thereof. Preferably, the proteolysate is a proteolysate of a protein chosen from the group consisting of αS1 casein, αS2 casein, β casein, κ casein, β-lactoglobulin and α-lactalbumin, and a mixture thereof.

According to another embodiment, the proteolysate is a casein proteolysate, preferably a proteolysate of a casein chosen from the group consisting of αS1 casein, αS2 casein, β casein, κ casein, and a mixture thereof.

According to yet another embodiment, the proteolysate is a proteolysate of a protein chosen from the group consisting of αS1 casein, αS2 casein, β-lactoglobulin, α-lactalbumin, and a mixture thereof.

According to one particular embodiment, the proteolysate is an α casein proteolysate, i.e. a proteolysate of a protein chosen from the group consisting of αS1 casein and αS2 casein, and a mixture thereof.

According to another particular embodiment, the proteolysate is a serum protein proteolysate, preferably a proteolysate of a protein chosen from the group consisting of β-lactoglobulin and α-lactalbumin, and a mixture thereof.

The enzymatic digestion conditions are preferably adjusted so as to obtain digestion of virtually all the milk proteins present in the reaction medium. According to one particular embodiment, the proteolysate obtained comprises less than 20% by weight of undigested proteins, preferably less than 10% by weight of undigested proteins, and more particularly preferably less than 5% by weight of undigested proteins. As used in the present document, the term “undigested protein” refers to a protein having undergone no enzymatic hydrolysis. The efficiency of the enzymatic digestion can be easily evaluated by those skilled in the art by means of routine techniques, such as electrophoresis techniques.

After digestion, the proteolysate can be subjected to a fractionation process in order to separate the peptides according to their physicochemical properties. In particular, the peptides contained in the proteolysate can be fractionated according to their sizes, for example by gel filtration or by ultrafiltration via centrifugation, or their charges, for example by ion exchange chromatography. The various protein fractionation techniques are well known to those skilled in the art.

According to one embodiment, the proteolysate is subjected to a size fractionation, preferably by ultrafiltration via centrifugation.

According to one particular embodiment, the proteolysate comprises essentially peptide fragments having a molecular weight greater than 3 kDa.

According to another particular embodiment, the proteolysate comprises essentially peptide fragments having a molecular weight greater than 10 kDa.

According to yet another embodiment, the proteolysate comprises essentially peptide fragments having a molecular weight of between 3 and 10 kDa.

According to one particular embodiment, the proteolysate comprises essentially peptide fragments of which the molecular weight is greater than 3 kDa, and which are obtained by digestion of caseins, preferably of α caseins, with chymotrypsin or trypsin.

According to another particular embodiment, the proteolysate comprises essentially peptide fragments of which the molecular weight is greater than 10 kDa, and which are obtained by digestion of caseins, preferably of α caseins, with chymotrypsin or trypsin.

According to another particular embodiment, the proteolysate is obtained from digestion of α caseins with trypsin or chymotrypsin and comprises essentially peptide fragments having a molecular weight greater than 3 kDa, preferably greater than 10 kDa.

According to yet another particular embodiment, the proteolysate comprises essentially peptide fragments of which the molecular weight is greater than 10 kDa, and which are obtained by digestion of serum proteins, preferably β-lactoglobulin and/or α-lactalbumin, with chymotrypsin or trypsin, preferably with chymotrypsin.

Before use, the proteolysate can also by lyophilized, dried, or subjected to dialysis steps.

The inventors have demonstrated that the proteolysate described below is capable of promoting the proliferation of bone marrow progenitor cells, the differentiation of osteoprogenitors into osteoblasts and/or osteoblast activity.

The term “bone marrow progenitor cells”, as used in this document, refers to multipotent stem cells which can differentiate into various cell types. The bone marrow progenitor cells comprise in particular mesenchymal stem cells (or osteoprogenitor cells) capable of differentiating into osteoblasts and then into osteocysts, and haematopoietic stem cells capable of differentiating into osteoclasts.

According to one embodiment, the proteolysate promotes the proliferation of bone marrow progenitor cells. Preferably, the proteolysate promotes the proliferation of mesenchymal stem cells (or osteoprogenitor cells) capable of differentiating into osteoblasts. The activity of the proteolysate on cell proliferation can be evaluated by means of techniques well known to those skilled in the art, for example by quantification of the total DNA in a culture containing bone marrow progenitor cells, produced in the presence of the proteolysate. The amount of total DNA is then compared with the amount obtained in an identical culture produced without the addition of the proteolysate and in the presence of bovine serum albumin (neutral control).

According to another embodiment, the proteolysate promotes the differentiation of osteoprogenitor cells into osteoblasts. The activity of the proteolysate on the differentiation of osteoprogenitor cells into osteoblasts can be evaluated by means of techniques well known to those skilled in the art, for example by measuring the alkaline phosphatase activity in a culture containing bone marrow progenitor cells and/or osteoprogenitor cells, produced in the presence of the proteolysate. Indeed, alkaline phosphatase is produced only by differentiated osteoblasts or osteoblasts undergoing differentiation (P. Marie. Med Sci (Paris) 17 12 (2001) 1252-1259).

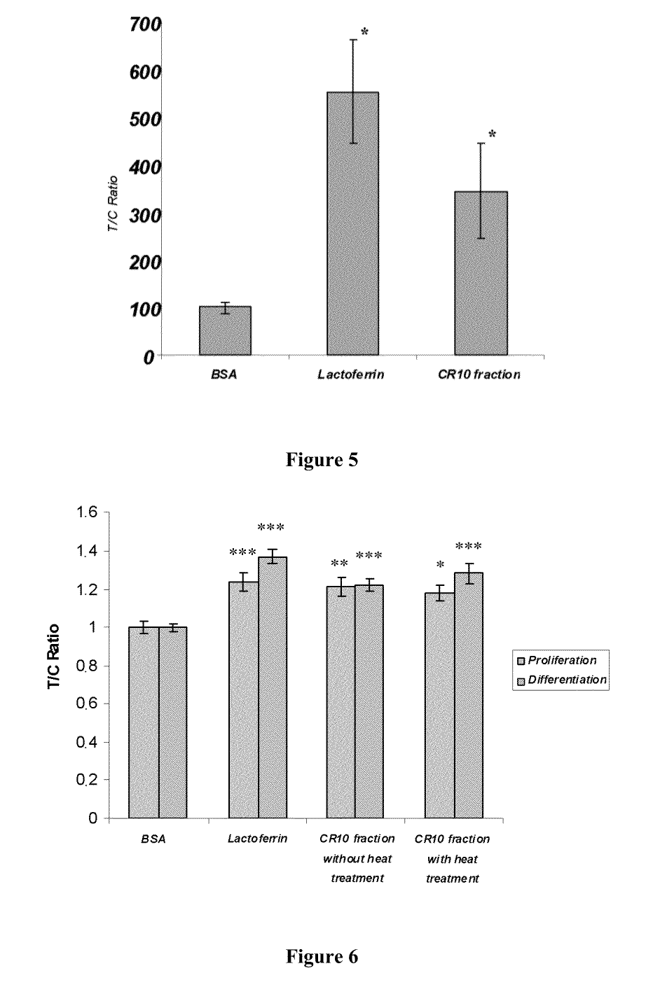

According to yet another embodiment, the proteolysate promotes osteoblast activity. The inventors have in fact demonstrated the stimulating action of the proteolysate on osteoblast activity, and in particular on osteoblast mineralization activity (FIGS. 4 and 5). The activity of the proteolysate on mineralization can be monitored by any method known to those skilled in the art, in particular by staining mineralization nodules with alizarin red in a culture containing osteoblasts and produced in the presence of proteolysate.

According to one preferred embodiment, the proteolysate promotes both the proliferation of bone marrow progenitor cells, in particular of osteoprogenitor cells, and the differentiation of said cells into osteoblasts.

According to one particularly preferred embodiment, the proteolysate promotes the proliferation of bone marrow progenitor cells, in particular of osteoprogenitor cells, the differentiation of said cells into osteoblasts, and osteoblast activity, in particular on mineralization of the osteoid.

Optionally, the proteolysate can also inhibit the proliferation, differentiation and/or resorption activity of osteoclasts. Osteoclast differentiation can be evaluated by means of techniques well known to those skilled in the art, for example by TRAP labelling (Tartrate Resistant Alkaline Phosphatase; Ballanti et al., Osteoporos Int. 1997; 7 (1):39-43). The resorption activity of osteoclasts can also be evaluated by means of techniques well known to those skilled in the art, for example by culturing the cells on dentine plates and by measuring the size of the areas of resorption.

The proteolysate according to the invention is used for the preparation of a food composition.

The food composition may be intended for animal or human consumption, preferably for human consumption.

The food composition may in particular be a food, a beverage or a food supplement. The term “food” as used in the present document refers to a substance or product intended to be ingested for nutritional or energy purposes. The term “food supplement” as used herein refers to a substance or product intended to be ingested in order to provide a supplement to a diet.

According to one embodiment, the composition is a food supplement.

According to another embodiment, the composition is a food.

According to one particular embodiment, the composition is a beverage.

According to one preferred embodiment, the food composition is a dairy product, in particular a fermented milk or an unripened cheese. According to one particular embodiment, the food composition is a fermented milk, preferably a yoghurt. According to another particular embodiment, the food composition is an unripened cheese, preferably a fresh cheese.

The food composition can be consumed occasionally or regularly. According to one embodiment, the composition is intended to be consumed regularly, preferably one or more times per week, and more particularly preferably every day or every other day.

The proteolysate may be present in the food composition in a concentration of 0.1 g/100 g to 10 g/100 g of final product, preferably of 0.1 g/100 g to 6 g/100 g of final product.

The present invention also relates to a food composition, as defined above, comprising the proteolysate according to the invention and capable of promoting the proliferation of bone marrow progenitor cells, the differentiation of said cells into osteoblasts and/or osteoblast activity. All the embodiments concerning the proteolysate described above are also included in this aspect of the invention.

Other characteristics and advantages of the invention will emerge more clearly on reading the following examples given by way of non-limiting illustration.

### EXAMPLES

### Example 1

### Effect of the Milk Protein Proteolysates on Bone Cell Proliferation and Osteoblast Differentiation

### Materials and Methods

### Obtaining Peptide Fractions and Proteolysates

Three fractions of milk proteins comprising a) total caseins (αS1, αS2, β and κ) (C5890, Sigma), b) αS1 and αS2 caseins (C6780, Sigma) and c) serum proteins (Prolacta 90, Lactalis Ingredients) were subjected to enzymatic digestion using trypsin (T0303, Sigma) or chymotrypsin (C4129, Sigma) in a 1:50 proportion, for 1 hour at 37° C. in an appropriate buffer. The fractions thus digested were then subjected to ultrafiltration with a cut-off threshold of 10 kDa (UFC801096 filter, Amicon Ultra). The ultrafiltrates were again ultrafiltered with a cut-off threshold at 3 kDa (UFC800396 filter, Amicon Ultra). The retentates obtained by means of the ultrafiltrations at 10 and 3 kDa were then lyophilized in order to remove the buffer (Lyovac GT2, Finn-Aqua).

### Cell Culture

The effectiveness of the undigested protein fractions and of the proteolysates were tested on primary cultures of bone cells.

After sacrifice of a C3H mouse (Harlan), the tibias and femurs were removed, ground and then filtered sterilely. The bone cells contained in the filtrate were seeded into 48-well plates (3548, Costar) in an α-MEM culture medium (α-Minimum Essential Medium BE02-002F, Lonza) containing 10% of foetal calf serum (DE14-801F, Lonza) and 10⁻⁸ M of 1,25-dihydroxyvitamin D3 (D1530, Sigma). The cells were kept in an incubator at 37° C. and 5% CO₂. The medium was changed twice a week after agitation in order to take off the floating cells. The observation of these ground materials, under a microscope, after Giemsa staining, showed that they comprised approximately 90% of osteoblasts and 10% of osteoclasts.

After 6 days of culture, the cells were brought into contact with the peptide fractions at 0.1 mg/ml. Bovine serum albumin (BSA, A4503, Sigma) was used as a neutral control. Lactoferrin (Fonterra), a milk protein known to have a positive effect both on proliferation and on differentiation of osteoblasts (Blais et al. Am J Physiol Endocrinol Metab, Vol. 296, No. 6, (June 2009), pp. E1281-1288), was used as a positive control.

The cell culture was continued for 14 days in the presence of the peptide fractions or of the control proteins. Two parameters were then measured in the cultures: the amount of DNA and the alkaline phosphatase activity. The amount of DNA reflects the number of cells present in each well and is therefore an indicator of proliferation. It was measured by fluorimetry according to the manufacturer's instructions (Fluoreporter Kit F2962, Invitrogen). Alkaline phosphatase is an enzyme which is produced only by differentiated osteoblasts or osteoblasts undergoing differentiation. Its activity is therefore a marker for differentiation. It was measured by colorimetry according to the manufacturer's instructions (ALP/PAL kit R5A655A, IDS). The alkaline phosphatase activity was corrected by the number of cells present in the well (measured via the DNA). The alkaline phosphatase activity is therefore expressed by the ratio of the alkaline phosphatase measurement to the DNA measurement.

The results are presented in the form of a ratio of the values obtained with the sample tested to the values obtained with the neutral control, i.e. with bovine serum albumin (T/C ratio). These ratios are calculated for each culture plate and then grouped together. A Student's statistical test makes it possible to determine whether the T/C ratio of each treatment is different from that of the neutral control (equal to 1). The difference is considered to be significant if the statistic p of the Student's test is less than 0.05.

### Results

### Effect of the Undigested Total Caseins and of the Total Casein Proteolysates

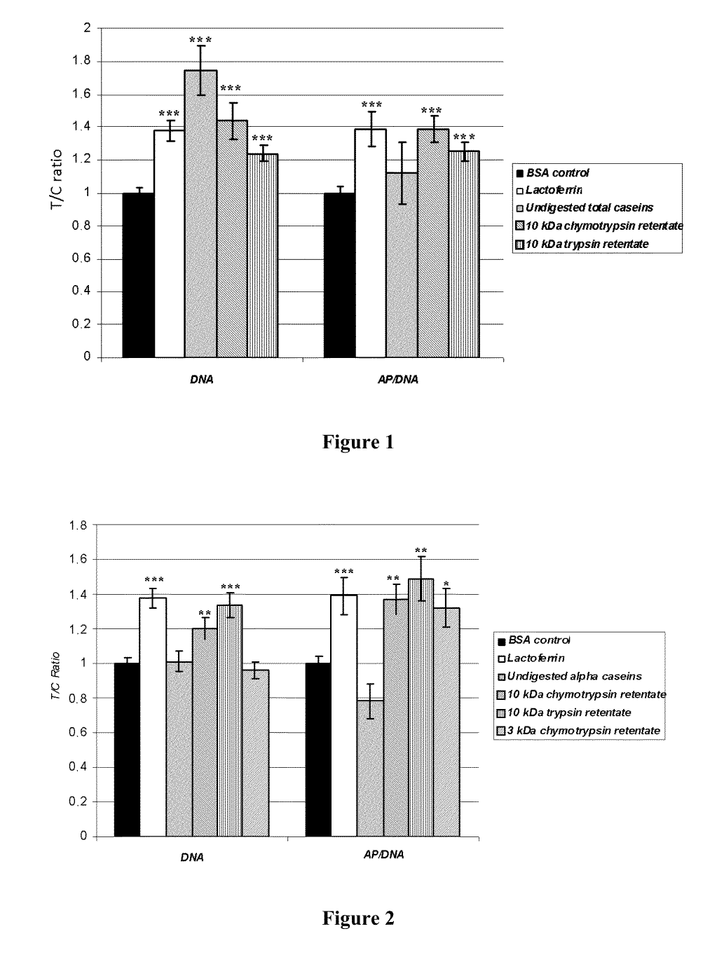

The results obtained are presented in FIG. 1.

These results demonstrate that the undigested total caseins have a positive effect on bone cell proliferation. On the other hand, they have no effect on osteoblast differentiation.

On the other hand, the proteolysates obtained by digestion of the total caseins with trypsin or chymotrypsin, and comprising peptides having a molecular weight greater than 10 kDa, have a positive effect both on bone cell proliferation and on osteoblast differentiation.

### Effects of the Undigested α Caseins (αS1 and αS2) and of the α Casein Proteolysates

The results obtained are presented in FIG. 2.

These results demonstrate that the undigested αS1 and αS2 caseins have no effect on bone cell proliferation or osteoblast differentiation.

On the other hand, the proteolysates obtained by digestion of α caseins with trypsin or chymotrypsin, and comprising peptides having a molecular weight greater than 10 kDa or of between 3 and 10 kDa, have a positive effect on osteoblast differentiation. The proteolysates comprising peptides having a molecular weight greater than 10 kDa also have a positive effect on bone cell proliferation.

### Effects of the Undigested Serum Proteins and of the Serum Protein Proteolysates

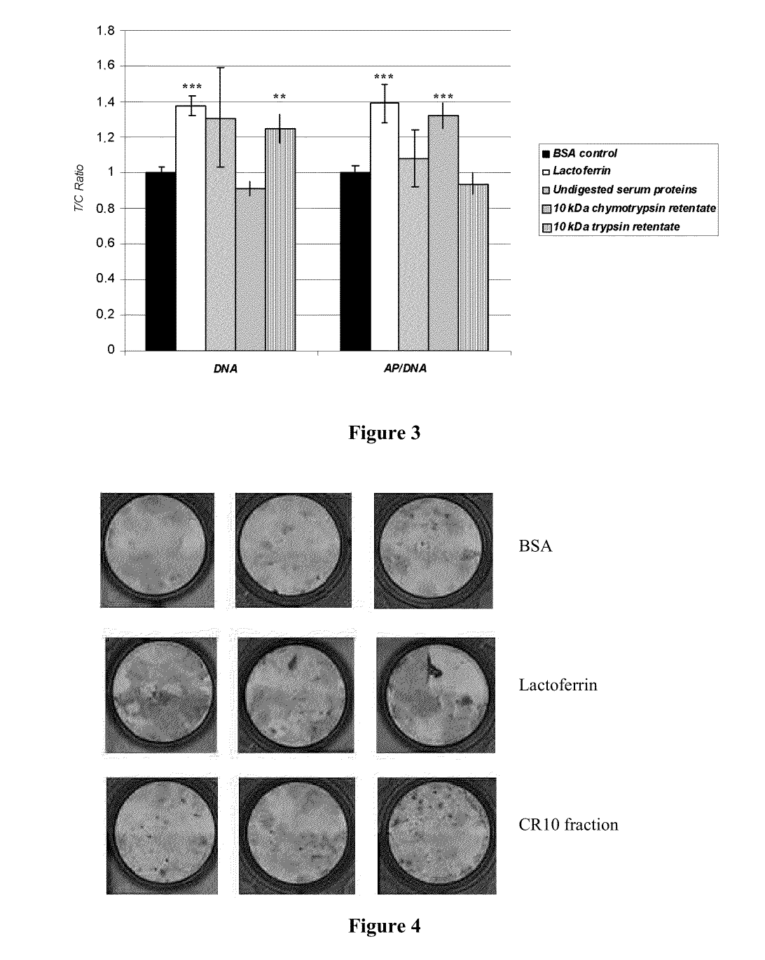

The results obtained are presented in FIG. 3.

These results demonstrate that the undigested serum proteins have no effect on bone cell proliferation or osteoblast differentiation.

On the other hand, the proteolysates obtained by digestion of serum proteins with trypsin or chymotrypsin, and comprising peptides having a molecular weight of greater than 10 kDa, have a positive effect on osteoblast differentiation or bone cell proliferation.

### Example 2

### Effects of the Milk Protein Proteolysates on Bone Matrix Mineralization

### Materials and Methods

### Obtaining the Proteolysate

A fraction of milk proteins containing caseins (αS1, αS2, β and κ) (C5890, Sigma) was subjected to enzymatic digestion using chymotrypsin (C4129, Sigma) in a 1:50 proportion, for 1 hour at 37° C. in an appropriate buffer. The fraction thus digested was then subjected to ultrafiltration with a cut-off threshold at 10 kDa (UFC801096 filter, Amicon Ultra). The retentate obtained was then lyophilized in order to remove the buffer (Lyovac GT2, Finn-Aqua). The proteolysate thus obtained is hereinafter referred to as CR10.

### Cell Culture

Three 4-week-old male Sprague-Dawley rats were sacrificed. The bone marrow of the tibias and femurs was collected and the bone marrow cells were isolated by centrifugation. The cells were then seeded into 6-well plates and cultured for 4 days in DMEM medium (Lonza) with 10% foetal calf serum (Hyclone) in order to select the mesenchymal stem cells (sorting by adhesion).

The mesenchymal stem cells were cultured in the presence of 0.01 mg/ml of BSA (neutral control), of 0.01 mg/mL of lactoferrin (positive control) or of 0.01 mg/ml of CR10. Each condition was performed in triplicate.

After 4 days of culture, 50 μg/ml of ascorbic acid and 10 mM of β-glycerophosphate were added to each well in order to stimulate the differentiation of the mesenchymal stem cells into osteoblasts.

After 4 more days of culture in the presence of these differentiation factors, the cultures were stained with alizarin red in order to demonstrate mineralization nodules (the alizarin red binds to the calcium deposits of the osteoblasts). The nodules were then dissolved and the strength of the staining in the resulting solution was measured by spectrophotometry (Sunrise-Basic microplate reader, Tecan).

### Results

The results presented in FIGS. 4 and 5 show that the CR10 fraction, which is a casein proteolysate comprising essentially peptides of more than 10 kDa, has a positive effect on bone matrix mineralization, i.e. on osteoblast activity.

### Example 3

### Proteolysate Stability

The CR10 proteolysate obtained according to the protocol described in detail in Example 2 was subjected to heat treatment (96° C. for 4 min) before the lyophilisation step. Its activity on bone cell proliferation and on osteoblast differentiation was then evaluated according to the protocol described in detail in Example 1.

The results obtained are presented in FIG. 6.

These results show that the heat treatment does not modify the stimulatory activity of the proteolysate on bone cell proliferation and on osteoblast differentiation.

1-30. (canceled)

31. A method of preparing a food composition for promoting the proliferation of bone marrow progenitor cells, the differentiation of said cells into osteoblasts and/or osteoblast activity comprising forming a proteolysate of one or more milk proteins selected from the group consisting of caseins, β-lactoglobulin, α-lactalbumin, and a mixture thereof.

32. The method according to claim 31, wherein the proteolysate is a proteolysate of a protein selected from the group consisting of αS1 casein, αS2 casein, β casein, κ casein, β-lactoglobulin, α-lactalbumin, and a mixture thereof.

33. The method according to claim 31, wherein the proteolysate is casein proteolysate.

34. The method according to claim 31, wherein the proteolysate is a proteolysate of a protein selected from the group consisting of β-lactoglobulin, α-lactalbumin, and a mixture thereof.

35. The method according to claim 31, wherein the proteolysate is obtained by digestion with one or more enzymes having an endopeptidase and/or exopeptidase activity.

36. The method according to claim 35, wherein the enzyme(s) is (are) selected from the group consisting of serine endopeptidases, cysteine endopeptidases, aspartate endopeptidases and metallo-endopeptidases.

37. The method according to claim 36, wherein the enzyme(s) is (are) selected from one or more serine endopeptidases.

38. The method according to claim 31, wherein the proteolysate is obtained by digestion with an enzyme selected from the group consisting of chymotrypsin and trypsin, and a mixture thereof.

39. The method according to claim 31, wherein the proteolysate is obtained by digestion with chymotrypsin.

40. The method according to claim 31, wherein the proteolysate is obtained by digestion with trypsin.

41. The method according to claim 31, wherein the proteolysate is obtained by microbial fermentation.

42. The method according to claim 31, wherein the proteolysate is subjected to size fractionation before formulation into a food product.

43. The method according to claim 42, wherein the size fractionation is ultrafiltration by centrifugation.

44. The method according to claim 31, wherein the proteolysate comprises peptide fragments having a molecular weight greater than 3 kDa.

45. The method according to claim 31, wherein the proteolysate comprises peptide fragments having a molecular weight greater than 10 kDa.

46. The method according to claim 31, wherein the proteolysate comprises peptide fragments having a molecular weight of between 3 and 10 kDa.

47. The method according to claim 31, wherein the proteolysate promotes the proliferation of bone marrow progenitor cells and the differentiation of said cells into osteoblasts.

48. The method according to claim 31, wherein the proteolysate promotes osteoblast activity.

49. The method according to claim 31, wherein the food composition is a food, a food supplement or a beverage.

50. The method according to claim 31, wherein the food composition is a dairy product.

51. The method according to claim 50, wherein the dairy product is a fermented milk or an unripened cheese.

52. The method according to claim 51, wherein the fermented milk is a yoghurt.

53. The method according to claim 51, wherein the unripened cheese is a fresh cheese.
